(19) United States
(12) Patent Application Publication
(10) Pub. No.: US 2023/0294335 A1
(43) Pub. Date: Sep. 21, 2023

(54) METHOD OF MANUFACTURING A MOLDING TOOL FOR PRODUCING AN EQUIPMENT PART AND METHOD OF MANUFACTURING AN EQUIPMENT PART AND EQUIPMENT PART

(71) Applicant: GRAMMER AG, Ursensollen (DE)

(72) Inventors: Manfred RICHTHAMMER, Thanheim (DE); Stefan GRAML, Ursensollen (DE); Stefan TAMSEN, Straubing (DE)

(21) Appl. No.: 18/113,763

(22) Filed: Feb. 24, 2023

(30) Foreign Application Priority Data
Feb. 24, 2022 (DE) 10 2022 104 495.5

(51) Int. Cl. B29C 33/42; B29C 44/24; B29C 33/38; B29C 67/24

(52) U.S. Cl. CPC B29C 33/424; B29C 44/24; B29C 33/3842; B29C 67/246; B29K 2075/00

(57) ABSTRACT

A method for producing a head support, including the steps of providing a mold having at least two mold parts and a cavity, wherein the mold includes at least regions of the inner surface of the cavity which are configured to produce an outer surface of an equipment part and have a structure which is in the form of a negative structure, which is to be produced, of a structure of the outer surface of the equipment part, coating the inner surface of the cavity with a first complex of material, drying the first complex, introducing a second material into a mold part of the open mold and then closing the mold, opening the mold after the second complex has cured.

### The invention relates to a method for producing a molding tool. The molding tool is provided for the production of a head support. It comprises at least two mold parts.

It is known from the prior art, for which there is no documentary evidence, to provide regions of the mold that form outer surfaces with a structure. The structure imitates, for example, the outer surface of a leather skin or of a seam. For this purpose, the inner surface of the mold cavity was subjected to treatment, for example, by etching processes or spark erosion. These methods were very expensive and time-consuming.

The object of the invention was to provide a method for producing a molding tool for the production of an equipment part, which ensures simple production of the mold and wherein the appearance of the equipment part can easily be adapted in terms of color and structure to the client's requirements.

The object has been achieved by a method having the features of claim 1.

In the method, datasets of the parts of the molding tool, for example CAD datasets, are first generated. By means of a special texturing software, the data are supplemented in respect of the structure of at least one surface of the molding cavity which later forms an outer surface of the product. By means of the software it is possible, for example, to provide a surface of the mold cavity with a structure which visually corresponds to a leather skin or a textile cover. It is also possible, for example, to form in the dataset a structure which imitates at least one seam. Elevations, depressions, advertising logos, etc. can also be incorporated into the outer surface.

The mold parts of the tool are printed in a 3D printer using the dataset modified by the additional software. The generated structure of at least one surface of the mold cavity forms a negative structure, which is later molded on production of the mold part. The mold cavity is formed, for example, by multiple mold parts.

The advantage of this method is, inter alia, that, with a relatively low effort in terms of production, it is possible to produce molding tools which, by the use of the texturing software, can be adapted to the client's requirements in relation to the outer structure of the equipment part to be produced.

According to one embodiment, the mold parts are, for example, shot-blasted after they have been printed, in order to remove loose particles from the printing process from the mold part in question. A particle jet is thereby blown onto the mold part at high speed, so that loose particles are detached from the mold part.

For example, the mold parts are provided with a dark, in particular a black, paint. The color increases the heat absorption, which is important for a method step which will be explained below. The black paint reflects the thermal radiation less, so that the mold part heats up more quickly. This method step also contributes to the closing of pores in the inner surface of the mold cavity, for example between the powder particles used in the printing of the mold part.

The mold parts, for example two mold halves, are, for example, heated in a furnace in a constrained position relative to one another. The temperature is, for example, approximately from 100 to 150°, in particular 120°. By means of this method step, the mold parts are deformed slightly, so that, for example, sealing faces rest closely one on top of the other The material introduced into the mold cavity is thereby prevented from later escaping from the mold. Post-machining of the equipment part produced can thus be avoided because, in this manner, no burrs have to be removed from the finished mold part which have formed as a result of material which has escaped from between the mating points of the mold parts.

After heating, the surface of the mold cavity is, for example, coated with a sealant, for example in order to close pores and cracks and to produce a closed surface. Commercially available sealants can be used for this purpose.

All printable materials can be used as the material for the mold. Plastics material is suitable in particular for inexpensive production and easy processing. Alternatively, composite materials, for example composite plastics, or metals can be used.

For example, a mold core can be arranged in the mold cavity. A hollow space can be produced in the equipment part by means of the mold core.

According to a second aspect, the invention relates to a method for producing an equipment part of a vehicle.

It is known from public prior use to fasten a base part of a head support to two support bars or to a support bar bracket. The base part was provided with a foam part which, for example, was pulled over the base part. The foam part was produced in a molding tool using a polyurethane foam. By means of a mold core, a hollow space for receiving the base part was produced in the foam part. After the foam part had been mounted on the base part, the assembly was provided with a cover. The cover was prepared from cut-to-size fabric, leather or synthetic leather produced for the head support in question, which had to be stitched together. Deficiencies occurring in the individual method steps often led to parts being discarded.

It is known from EP 2 511 127 B1 to place a cover into a mold which is provided for producing a head support. At least one holding bar is positioned relative to the mold. Alternatively, a mold core is positioned relative to the mold. A foam is introduced into the mold. After curing of the foam, the finished head support could be removed from the mold.

The object of the invention was to provide a method for producing an equipment part for a vehicle which is improved in respect of the outlay in terms of production and the costs associated therewith. Nevertheless, it is to be possible to configure the equipment part flexibly in accordance with the client's requirements.

The object has been achieved by a method for producing an equipment part having the features of claim 8.

A molding tool having at least two mold parts which are movable relative to one another is provided. The mold parts form a cavity in which an equipment part can be produced. For example, the mold cavity is formed by at least two mold parts. At least regions of the inner surface of the mold cavity of the molding tool are configured for producing an outer surface of the equipment part and comprise a structure which forms a negative structure of a structure of the outer surface of the equipment part. In particular, the molding tool is configured in accordance with the first aspect of the invention.

At least some of the regions of the inner surface that form an outer surface of the equipment part are coated with a first complex comprising at least one layer of at least one material. This first layer complex also comprises the structure, also called the texture, which is visually apparent and palpable to the occupants of the vehicle in the finished product. For example, only one layer of one material is applied. Alternatively, multiple layers of the same material are applied. According to a further alternative, at least one layer of a first material and at least a second layer of at least one other material are applied.

Application takes place, for example, by spraying, pouring and brushing or other suitable methods. All suitable methods with which the layer complex can be evenly distributed on the inner surface of the mold part can be used here. In this manner, all the regions of the inner surface of the mold cavity that produce an outer surface are provided with the layer complex. That is to say, where multiple mold parts form the mold cavity, the method is also carried out on those mold parts.

After the first layer complex has been produced or after at least one layer has been applied, drying is carried out. That is to say, each layer can be dried separately. Alternatively, multiple layers or all the layers are dried together.

Thereafter, the second complex of material is introduced into one of the mold parts, which comprises part of the cavity. After the material complex has been introduced, the mold is closed. According to an alternative, the introduction can also take place into the closed mold through at least one gate.

After a curing time of the second complex which may be necessary, and after the time required for the second complex to adhere to the first complex, the mold is opened and the finished equipment part is removed from the mold.

By means of the features of the method according to the invention of the second aspect of the invention, it is possible to produce, with a small number of method steps, an equipment part which has an almost identical, at least very similar, appearance compared to an equipment part that has been manufactured in a much more complex manner, that is to say, for example, has been provided with a material cover or a leather cover, wherein parts of the cover are stitched. In the method according to the invention, owing to a significantly smaller number of method steps, a lower outlay in terms of production and material and thus lower production costs are achieved.

According to one embodiment, before or after the method step of drying the first complex, an integral part which remains in the product or a mold core which is removed from the equipment part after the manufacture thereof is mounted in a defined position relative to at least one mold part. It can be mounted, for example, on a mold part or on a mold carrier on which the mold parts are mounted so as to be movable between an open and a closed position. In the open position the mold cavity is accessible, and in the closed position the mold cavity is closed so that material which has been introduced cannot escape.

Drying takes place, for example, by means of an IR radiator. Alternatively, drying in a heating chamber is also possible. Drying of the layer complex by other suitable methods which do not adversely affect the desired properties of the material, such as elasticity and insensitivity to cracks and fracture, is also possible.

Before the first complex is applied to surfaces of the mold cavity, regions of the mold parts are provided with a mask. This method step prevents parts of the sealing faces from being wetted with material on application of the first and second complexes and the tightness of the molding tool then no longer being ensured.

At least one material of the first complex is formed, for example, by a polyurethane (PUR) lacquer, a PUR-RIM (reaction injection molding) or a PUR-RRIM (reinforced reaction injection molding). Alternatively, other suitable materials can be used.

For example, the material of the layers of the first complex has good deformability and elasticity, so that no fractures or cracks occur. This is because the finished equipment part is a cushioned part, wherein at least one outer surface in the form of a support surface or contact surface is resilient.

For example, there is good suitability for adhesion to the second complex of material with which the first complex is back-filled.

In addition, the haptics, for example, of the material of the first complex plays a part, which can be adapted to the client's requirements.

The second complex of material comprises, for example, a PUR foam. Alternatively, other materials which adhere to the first complex can also be used. Such materials can also be, for example, composite materials which comprise a PUR foam component and also at least one further constituent. The further constituent can have, for example, reinforcing properties. For example, the constituent can be formed by fibers. Reference is made to DE 10 2021 005 049, the disclosed content of which is explicitly incorporated into the disclosure of this application.

According to a third aspect, the invention relates to an equipment part for a vehicle.

There is known from public prior use an equipment part in which, in a so-called in-seat method, a foam is molded onto a base body and also onto a textile cover produced beforehand from multiple parts.

The object of the invention was to provide an equipment part which can be produced in a simple manner and gives rise to low costs in relation to the material.

The object is achieved by an equipment part having the features of claim 16.

The equipment part comprises an outer skin with an outer surface, wherein the outer skin is formed by a first complex of material comprising at least one plastics material, and wherein the outer surface is provided with a structure. The outer skin is carried by a filler of a second complex of material. The outer skin and the filler are bonded together.

The equipment part is produced in particular by the method of the second aspect of the invention.

The equipment part is, for example, a head support, an armrest or a center console.

Exemplary embodiments of the invention are described by way of example in the following description of the figures, also with reference to the drawings. In the drawings, for the sake of clarity—also where different exemplary embodiments are concerned—identical or comparable parts or elements or regions are designated with identical reference signs, in some cases with the addition of lowercase letters.

Features which are described only in relation to one exemplary embodiment can also be provided within the scope of the invention in any other exemplary embodiment of the invention. Such modified exemplary embodiments—even if they are not shown in the drawings—are included in the invention.

All the disclosed features are in themselves essential to the invention. The disclosed content of the associated priority documents (copy of the previous application) as well as of the cited publications and of the described devices of the prior art is hereby also incorporated in its entirety into the disclosure of the application, also for the purpose of incorporating individual or multiple features of those supporting documents into one claim or into a plurality of claims of the present application.

In the drawings:

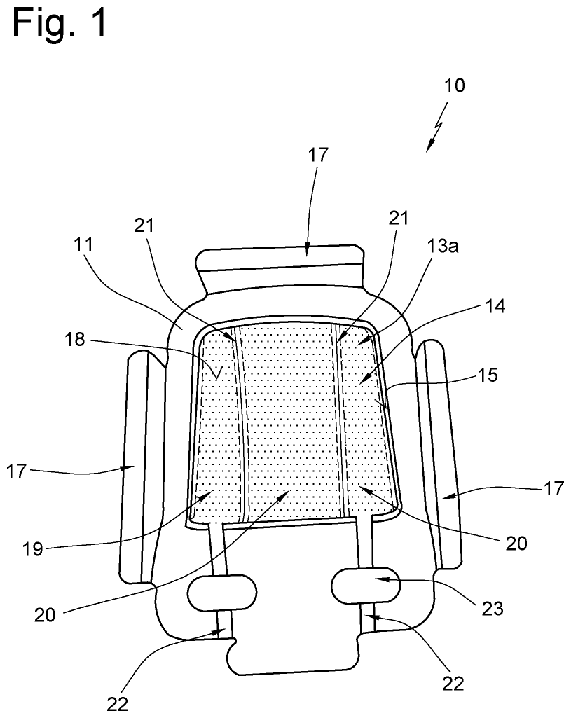

FIG. 1 is a plan view of a first mold part of a molding tool for producing an equipment part in the form of a head support, comprising a first part of a cavity,

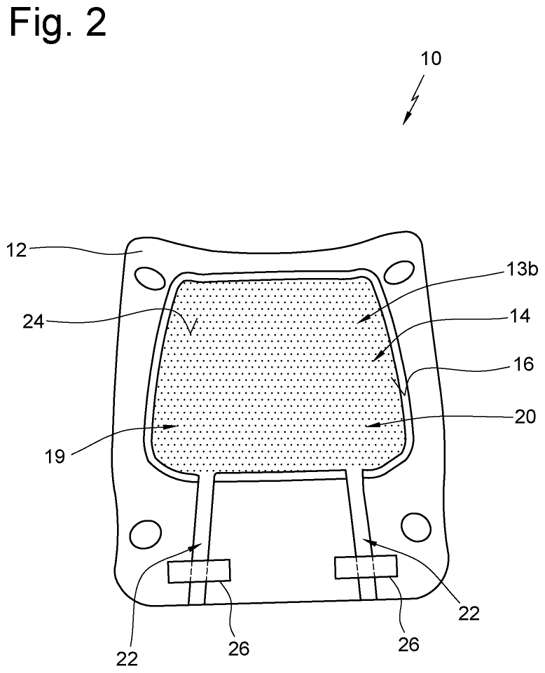

FIG. 2 is a plan view of a second mold part of the molding tool comprising a second part of a cavity,

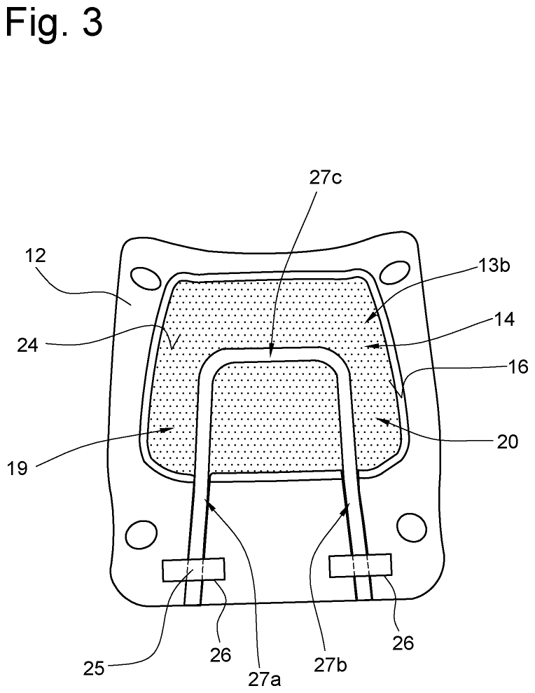

FIG. 3 is a plan view of the second mold part according to FIG. 2, wherein a holding bar bracket is fastened to the mold part,

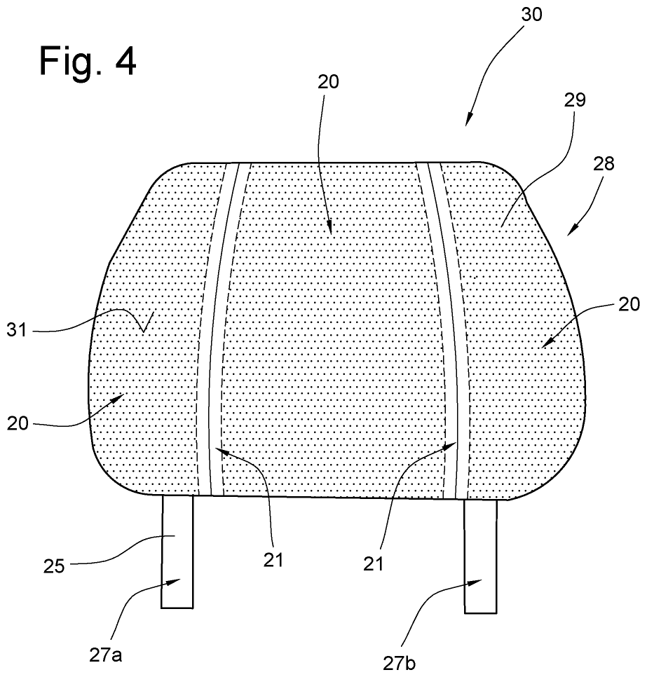

FIG. 4 is a front view of the mold part which has been produced,

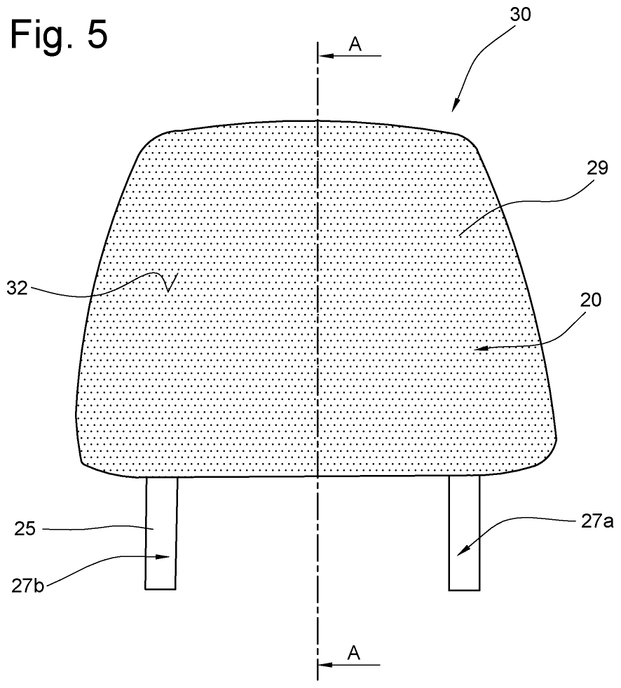

FIG. 5 is a rear view of the mold part which has been produced,

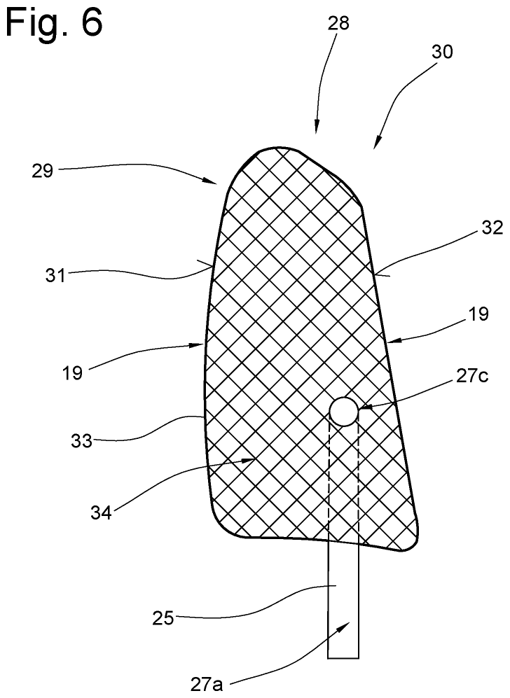

FIG. 6 is a sectional view along cutting line A-A in FIG. 5.

FIG. 1 shows a first mold part 11 of a molding tool 10 which is used to carry out the method according to the invention according to the second aspect of the invention. By means of the method, a cushioned upholstered equipment part of a vehicle can be produced, in which the outer surface is provided at least in part with a structure. For example—as in the present exemplary embodiment—the appearance and optionally the haptics of another material are imitated. The equipment part which is to be produced in the molding tool 10 is in the present example a head support.

The mold parts of the molding tool were produced in accordance with the first aspect of the invention. In this case, a CAD dataset was generated for producing the mold parts. By means of additional software, the dataset was supplemented with a negative structure at defined surfaces of a mold cavity of the mold, which structure is reproduced in the outer surface of the outer surface of the equipment part to be produced. The mold was then printed by means of a 3D printer.

The first mold part 11 comprises a part-cavity which together with a further part not shown in FIG. 1 forms the cavity 14. The equipment part is formed at least in part in the cavity 14. in which the equipment part

The mold part 11 additionally has centering attachments 17 with which the first mold part 11 can be aligned in a defined desired position relative to a second mold part 12 (see FIG. 2). In FIG. 1 there can further be seen a sealing face 15 which cooperates with a sealing face 16 of the second mold part 11.

An inner surface 18 of the part-cavity 13a is provided with a structure 19, also referred to as a texture. The structure 19 comprises regions 20 which visually and haptically imitate the structure of a leather skin, and regions 21 which visually imitate a seam.

On the first mold part 11 there are formed depressions 22 in which an integral part, in this exemplary embodiment end regions of a holding rod bracket, can be received in part, in order that another region, projecting into the cavity 14, of the holding rod bracket can later be formed in the equipment part. Cut-outs 23 serve to receive fasteners with which the holding rod bracket can be fastened to the second mold part 12.

In the second mold part 12 there is likewise formed a part-cavity 13b, which together with the part-cavity 13a forms the cavity 14 of the molding tool 10. A sealing face 16 is also formed on the second mold part 12. An inner surface 24 of the part-cavity 13b is provided with a structure 19 which has regions 20 of the imitation of a leather skin. The structure 19 has the shape of a negative and when molded is presented as a positive structure on the outer surface of the molded equipment part.

In a manner not shown, the mold parts 11 and 12 are mounted on a movable mold carrier with which the mold parts are movable between an open position and a closed position. In the closed position, the sealing faces 15 and 16 are in contact with one another and the cavity forms a substantially closed hollow space. In the open position, the two mold parts 11 and 12 are moved apart such that access to both mold parts 11 and 12 is possible.

For example, the mold parts 11 and 12 are moved apart vertically by a relative movement. One of the mold parts is stationary and the other mold part is movable, for example. In the present example, the mold part 12 is stationary and the part-cavity 13b faces upwards. The mold part 11 is movable and the part-cavity 13a faces downwards and is arranged above the part-cavity 13b.

First of all, in the open position, the sealing faces 15 and 16 are masked so that they remain free of any material which is applied onto the inner surfaces 18 and 24 of the part-cavities 13a and 13b. This prevents the sealing faces from leaks and material from escaping from the cavity 14. The inner surfaces 18 and 24 are then provided with a release agent which facilitates subsequent demolding of the equipment part which has been produced.

There is then applied onto the inner surfaces 18 and 24 a first complex of material which in a simple case, as in this exemplary embodiment, comprises a polyurethane paint. This complex, which can comprise one or more layers and which can have one or more materials, later forms an outer surface of the equipment part provided with the desired structure.

Drying of the first complex is then carried out. Drying takes place, for example, by means of at least one infra-red radiator which irradiates the inner surfaces 18 and 24.

A holding rod bracket 25 having free end regions 27a and 27b and a cross-piece 27c is then (see FIG. 3) arranged, for example, relative to the bottom second mold part 12. In the present example, the holding rod bracket 25 is fastened to the mold part 12 by means of a fastener 26.

A second complex of material is then introduced into the part-cavity 13b. The molding tool is then moved into the closed position and remains in the closed position until the second complex has cured and the second complex has bonded to the first complex. After curing, the molding tool 10 can be moved into the open position and the equipment part which has been produced can be removed from the bottom mold part 12.

FIG. 4 is a front view of an equipment part 28 in the form of a head support 30, which has been produced in the cavity 14. The head support comprises the holding rod bracket 25 and also a head part 29 having a front surface 31, which comprises the head-rest surface and was molded by the inner surface 18, and also a rear surface 32 (see FIG. 5), which was molded by the inner surface 24 of the cavity 14. The front surface 31 and the rear surface 32 contain the structure 19 having the regions 20 which imitate a leather skin. In this example, the front surface 31 additionally contains the regions 21 which imitate a double seam.

FIG. 6 is a sectional view of the head support 30. The head part 29 comprises an outer skin 33, which has been formed by the first complex of material, and a filling material 34, which has been formed by the second complex of material and which partially encloses regions of the holding rod bracket 25.

The outer skin 33 provided with the structure 19 adheres to the filling material, that is to say the first complex and the second complex have firmly bonded together.

In the present exemplary embodiment, the haptics of the first complex of material forming the outer skin 33 has also imitated the haptics of a leather skin.

1-16. (canceled)

17. A method for producing a molding tool having at least two mold parts and a cavity for production of at least one part of an equipment part, comprising the steps of: providing a dataset relating to the mold parts; supplementing the dataset using texturing software so that a structure is added to at least one surface of the cavity of the molding tool for producing at least one outer surface having a structure of the equipment part; and manufacturing an entire dataset relating to the mold parts on a 3D printer.

18. The method according to claim 17, wherein the structure forms an imitation leather, an imitation textile, or at least one imitation seam.

19. The method according to claim 17, further including, after the step of 3-D printing, shot-blasting the mold parts.

20. The method according to claim 17, further including applying a dark color to the mold parts heat absorption purposes.

21. The method according to claim 17, further including wedding the cavity with a sealant.

22. The method according to claim 17, further including subjecting the molding tool in a closed position to heat treatment in a constrained position.

23. The method according to claim 17, including producing the mold from a plastics material or a metal or a composite material.

24. A method for producing a vehicle equipment part, comprising the steps of:
providing a molding tool having at least two mold parts, wherein a cavity of the molding tool comprises at least regions of an inner surface that are configured for producing at least one outer surface of an equipment part and comprise a structure that forms a negative structure of the structure that is to be produced of the at least one outer surface of the equipment part;
coating an inner surface of a part-cavity of each mold part with a first complex of material;
drying the first complex,
introducing a second complex of material into the part-cavity and closing the molding tool, or introducing the second complex into the closed molding tool through a gate of the molding tool; and
opening the mold after the second complex has cured.

25. The method according to claim 24, further comprising the step of applying a release agent onto the inner surface of the cavity prior to the step of coating with the first complex.

26. The method according to claim 24, wherein the step of drying the first complex includes drying with at least one infra-red radiator after the step of applying the first complex.

27. The method according to claim 24, wherein the step of drying the first complex includes arranging the mold parts in a heating chamber after the step of applying the first complex.

28. The method according to claim 24, further comprising the step of masking at least sealing faces of the mold parts prior to the step of applying the first complex.

29. The method according to claim 24, comprising the first complex of material comprises a polyurethane foam, a polyurethane-reaction injection molding material or a polyurethane-reinforced reaction injection molding material.

30. The method according to claim 24, including the step of selecting at least one material of the first complex and at least one material of the second complex so that the first complex bonds to the second complex at least at a contact surface.

31. The method according to claim 24, including the step of selecting the material of the first complex so that it has high extensibility and/or deformability.

32. An equipment part for a vehicle, comprising an outer surface having at least one region provided with a structure, wherein the outer surface is formed by an outer skin of a plastics material, wherein the outer skin is carried by a filling material, and wherein the outer skin and the filling material are firmly bonded to one another.
